(19) United States
(12) Patent Application Publication
(10) Pub. No.: US 2023/0416428 A1
(43) Pub. Date: Dec. 28, 2023

(54) PROCESS

(71) Applicant: BOREALIS AG, Vienna (AT)

(72) Inventors: Tuan Anh TRAN, Linz (AT); Alexandra Romina ALBUNIA, Linz (AT); Qizheng DOU, Linz (AT); Victor SUMERIN, Kulloo (FI); Markku VAHTERI, Porvoo (FI); Jarmo KELA, Porvoo (FI)

(21) Appl. No.: 18/039,082

(22) PCT Filed: Nov. 26, 2021
(86) PCT No.: PCT/EP2021/083210

§ 371 Date: May 26, 2023

(30) Foreign Application Priority Data
Nov. 27, 2020 (EP) 20210369.3

(51) Int. Cl. C08F 210/16; C08J 5/18

(52) U.S. Cl. CPC C08F 210/16; C08J 5/18; C08J 2323/08; C08J 2423/08

(57) ABSTRACT

The invention provides a process for the preparation of a multimodal high density polyethylene (HDPE) having a density of greater than 950 kg/m, a Mz of at least 1000 kDa and a melt flow rate (MFR₅) of 0.01 to 4.0 g/10 min, said process comprising: (i) polymerising ethylene in a first polymerisation stage in the presence of a Ziegler-Natta catalyst to prepare a first ethylene homopolymer; (ii) polymerising ethylene in a second polymerisation stage in the presence of said catalyst and said first ethylene homopolymer to prepare an ethylene homopolymer mixture comprising said first ethylene homopolymer and a second ethylene homopolymer; and (iii) polymerising ethylene and at least one alpha-olefin comonomer in a third polymerisation stage in the presence of said catalyst and said ethylene homopolymer mixture to prepare said multimodal HDPE; wherein the split for the third polymerisation stage is at least 50%.

The present invention relates to a process for the production of a polyethylene polymer, in particular a high density polyethylene which is suitable for use in the manufacture of films. The present invention also relates to the polyethylene polymer itself, a film comprising said polymer and to the use of said polymer for the manufacture of a film. The process of the invention comprises three distinct polymerisation stages, producing a multimodal, high density polyethylene with a particular set of properties enabling the formation of films with advantageous features in terms of good processability and mechanical properties.

### BACKGROUND

One of the main uses of polyethylene (like HDPE, MDPE, LLDPE, mLLDPE, ULDPE, VLDPE, LDPE and ethylene based plastomers) or their blends is in film applications, such as grocery sacks, institutional and consumer can liners, merchandise bags, shipping sacks, food packaging films, multi-wall bag liners, produce bags, deli wraps, stretch wraps, and shrink wraps, etc.

The key physical parameters of polyethylene film include tear resistance, impact strength (i.e. dart drop impact, DDI), tensile strength, stiffness and clarity. Tear resistance is measured in machine direction (MD) and transverse direction (TD) and should be on a high level and simultaneously be quite similar in both directions, thus being balanced.

Film stiffness can be measured by tensile modulus. Modulus is the resistance of the film to deformation under stress.

LLDPE film has higher impact strength than MDPE, while HDPE has higher stiffness and tensile strength. When LLDPE producers attempt to increase the density (thereby increasing the modulus of the film), they often encounter losses in impact strength and MD tear resistance. Historically, blending LLDPE and HDPE has not achieved “breakthrough” success. The blends often give films that have improved stiffness and tensile properties, but the impact and tear properties are usually sacrificed. There are no straightforward methods or single resins that have the combined properties of both.

HDPE is widely used to manufacture films with a wide range of uses (for example, shrink films, shopping bags, etc.). HDPE film is also commonly used for food packaging, such as packaging cereals. Films used for food packaging require barrier properties (i.e., they should have moisture resistance) to prevent or minimize deterioration of the packaged product, thereby extending its shelf life. Typically, this is achieved by laminating a layer of HDPE film on a separate barrier layer. A typical barrier layer is made of aluminum or polyethylene terephthalate.

Unimodal HDPE film materials have a high stiffness, but limited processability and mechanical properties. The density may be reduced to improve the mechanical properties but this results in reduced stiffness.

Multimodal HDPE film materials also have high stiffness, but compared to unimodal materials they have good processability and good mechanical properties over a wider range of processing conditions as well. Typically these materials have been produced in cascaded slurry reactors as disclosed in WO 2014/001288. It is also possible to produce a bimodal HDPE film material in a more flexible process, such as those described in U.S. Pat. Nos. 6,562,905, 6,642,323, 6,455,642, comprising a combination of slurry and gas phase reactors, which provides for a wider variation of polymerization conditions. These methods may be preceded by a prepolymerisation step. However, attempts to reproduce the conventional materials made in a cascaded slurry process in this kind of a process have usually resulted in a material which cannot be used in film applications, due to either a limited processability or a too high gel level. Similar problems are encountered in processes comprising cascaded gas phase reactors.

Therefore, there is still a need for alternative HDPE films that have an excellent balance between mechanical and processing properties.

The present inventors have surprising found that employing at least a three stage polymerisation process, optionally preceded by a prepolymerisation step, leads to the production of polymers, specifically HDPE polymers, which have an improved balance of processability and mechanical properties, such as puncture resistance and impact performance, rendering them particularly suitable for use in film applications.

Multistage polymerisations comprising three stages have been described in, for example, WO 2010/054732, WO 2016/124676 and WO 2019/229209. The suitability of the products prepared by these processes specifically for film applications, is not, however, considered in any of these documents.

### SUMMARY OF INVENTION

Viewed from one aspect the invention provides a process for the preparation of a multimodal high density polyethylene (HDPE) having a density of greater than 950 kg/m³, a Mz of at least 1000 kDa and a melt flow rate (MFR₅) of 0.01 to 4.0 g/10 min, said process comprising:
(i) polymerising ethylene in a first polymerisation stage in the presence of a Ziegler-Natta catalyst to prepare a first ethylene homopolymer;
(ii) polymerising ethylene in a second polymerisation stage in the presence of said catalyst and said first ethylene homopolymer to prepare an ethylene homopolymer mixture comprising said first ethylene homopolymer and a second ethylene homopolymer; and
(iii) polymerising ethylene and at least one alpha-olefin comonomer in a third polymerisation stage in the presence of said catalyst and said ethylene homopolymer mixture to prepare said multimodal HDPE;
   wherein the split for the third polymerisation stage is at least 50%.

Viewed from another aspect, the invention provides a multimodal high density polyethylene (HDPE) having a density of greater than 950 kg/m³, a Mz of at least 1000 kDa and a melt flow rate (MFR₅) of 0.01 to 4.0 g/10 min, obtained by a process as hereinbefore defined.

Viewed from a further aspect, the invention provides a multimodal high density polyethylene (HDPE) having a density of greater than 950 kg/m³, a Mz of at least 1000 kDa and a melt flow rate (MFR₅) of 0.01 to 4.0 g/10 min, wherein said HDPE comprises a low molecular weight ethylene homopolymer component and a high molecular weight ethylene-butene copolymer component.

Preferably, the low molecular weight ethylene homopolymer component of the multimodal HDPEs as hereinbefore defined is an ethylene homopolymer mixture comprising a first ethylene homopolymer and a second ethylene homopolymer.

Viewed from another aspect, the invention provides a film comprising, such as consisting of, a multimodal HDPE having a density of greater than 950 kg/m³, a Mz of at least 1000 kDa and a melt flow rate (MFR₅) of 0.01 to 4.0 g/10 min, wherein said HDPE comprises a low molecular weight ethylene homopolymer component and at least 50 wt % of a high molecular weight ethylene copolymer component, relative to the total weight of the HDPE.

Viewed from a further aspect, the invention provides a process for the manufacture of a film, said process comprising preparing a multimodal HDPE as hereinbefore defined; and
extruding the composition to form a film.

Viewed from another aspect, the invention provides the use of the multimodal HDPE as hereinbefore defined in the manufacture of a film, preferably a blown film.

### DETAILED DESCRIPTION OF INVENTION

### Multimodal HDPE

It has been found that the high density polyethylene polymer according to the invention provides an improved material for film applications, which combines very good mechanical properties e.g. in terms of impact strength, puncture resistance and tensile modulus, with excellent processability (e.g. in terms of film thickness control).

The polymer of the invention is a multimodal high density ethylene polymer and is an ethylene copolymer. By ethylene copolymer is meant a polymer the majority by weight of which derives from ethylene monomer units (i.e. at least 50 wt % ethylene relative to the total weight of the copolymer). The comonomer contribution preferably is up to 10% by mol, more preferably up to 5% by mol. Ideally however there are very low levels of comonomer present in the polymers of the present invention such as 0.1 to 2.0 mol %, e.g. 0.1 to 1.0 mol %.

The other copolymerisable monomer or monomers are preferably C3-12, especially C3-10, alpha olefin comonomers, particularly singly or multiply ethylenically unsaturated comonomers, in particular C3-10-alpha olefins such as propene, but-1-ene, hex-1-ene, oct-1-ene, and 4-methyl-pent-1-ene. The use of 1-hexene, 1-octene and 1-butene, or mixtures thereof, is particularly preferred, especially 1-butene. Ideally there is only one comonomer present.

In the particular aspect of the invention relating to the HDPE itself, the polymer always comprises butene as the comonomer.

The polymer of the invention is multimodal and therefore comprises at least two components. The polymer of the invention preferably comprises (A) a lower molecular weight ethylene homopolymer component, and (B) a higher molecular weight ethylene copolymer component.

The HDPE of the invention is multimodal. Usually, a polyethylene composition comprising at least two polyethylene fractions, which have been produced under different polymerisation conditions resulting in different (weight average) molecular weights and molecular weight distributions for the fractions, is referred to as “multimodal”. Accordingly, in this sense the compositions of the invention are multimodal polyethylenes. The prefix “multi” relates to the number of different polymer fractions the composition is consisting of.

The form of the molecular weight distribution curve, i.e. the appearance of the graph of the polymer weight fraction as a function of its molecular weight, of such a multimodal polyethylene will show two or more maxima or at least be distinctly broadened in comparison with the curves for the individual fractions.

For example, if a polymer is produced in a sequential multistage process, utilising reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions are superimposed into the molecular weight distribution curve for the total resulting polymer product, usually yielding a curve with two or more distinct maxima.

The HDPE of the invention has a melt flow rate (MFR₅) of 0.01 to 4.0 g/10 min. Typically, the HDPE has an MFR₅ of 3.0 g/10 min or less, preferably 2.0 g/10 min or less, preferably 1.3 g/10 min or less, such as 0.9 g/10 min or less. The polymer preferably has a minimum MFR₅ of 0.05 g/10 min, such as greater than 0.1 g/10 min, preferably at least 0.15 g/10 min, ideally at least 0.2 g/10 min. Thus, particularly suitable values of MFR₅ are from 0.1 to 3.0 g/10 min, such as 0.15 to 2.0 g/10 min.

The polymer of the invention preferably has an MFR₂₁ of 2.5 to 12 g/10 min, such as 3.0 to 10 g/10 min, most preferably 5.0 to 9.0 g/10 min.

The polymer of the invention preferably has an MFR₂ of less than 0.1 g/10 min. Example ranges for MFR₂ are 0.01 to 0.095 g/10 min, such as 0.05 to 0.09 g/10 min.

The polymer of the invention preferably has a Flow Rate Ratio (FRR) of the MFR₂₁/MFR₅ of at least 15.0, like at least 20.0, more preferably at least 22.0 Furthermore, polymer of the invention preferably has a Flow Rate Ratio (FRR) of the MFR₂₁/MFR₅ of up to 40.0, like up to 37.0, more preferably up to 35.0.

The density of the polymer is greater than 950 kg/m³. The polymers of the invention are therefore high density polyethylenes, HDPE. More preferably, the polymer has a density of 951 kg/m³ or more, such as 952 kg/m³ or more.

Furthermore, the density of the polymer preferably is 970 kg/m³ or lower, and more preferably is 965 kg/m³ or lower. A typical density range is 951 to 960 kg/m³.

The HDPE polymer preferably has a molecular weight distribution Mw/Mn, being the ratio of the weight average molecular weight Mw and the number average molecular weight Mn, of 21 or more, such as 22 or more, more preferably of 23 or more.

The polymer preferably has an Mw/Mn of 35 or below, more preferably of 30 or below.

The weight average molecular weight Mw of the polymer preferably is at least 150 kDa, more preferably at least 200 kDa. Furthermore, the Mw of the composition preferably is at most 500 kDa, more preferably at most 400 kDa, such as at most 300 kDa.

The Mz/Mw ratio is preferably at least 4, more preferably at least 5.

The Mz/Mw ratio is preferably up to 10, more preferably up to 8.

Accordingly, the Mz/Mw ratio may be in the range of 4-10, like in the range of 5 to 8.

The actual value of Mz for the HDPE of the invention is at least 1000 kDa, such as in the range of 1200 kDa to 1500 kDa.

As noted above, the HDPE of the invention preferably comprises at least a lower molecular weight component (A) and a higher molecular weight component (B). In one particularly preferably embodiment, the HDPE consists of components (A) and (B). The weight ratio of fraction (A) to fraction (B) in the composition is typically in the range 30:70 to 70:30, more preferably 35:65 to 65:35, most preferably 40:60 to 60:40. In some embodiments the ratio may be 35 to 50 wt % of fraction (A) and 50 to 65 wt % fraction (B), such as 40 to 50 wt % of fraction (A) and 50 to 60 wt % fraction (B), e.g. 40 to 55 wt % of Fraction (A) and 55 to 60 wt % of Fraction (B).

In the particular aspect of the invention relating to a film comprising, such as consisting of, the HDPE, the HDPE comprises a low molecular weight ethylene homopolymer component (A) and at least 50 wt % of a high molecular weight ethylene copolymer component (B), relative to the total weight of the HDPE. In these embodiments, the ratio may be 35 to 50 wt % of fraction (A) and 50 to 65 wt % fraction (B), such as 40 to 50 wt % of fraction (A) and 50 to 60 wt % fraction (B), e.g. 40 to 55 wt % of Fraction (A) and 55 to 60 wt % of Fraction (B).

Fraction (A) is an ethylene homopolymer component and fraction (B) is an ethylene copolymer component. By ethylene homopolymer is meant a polymer comprising at least 97 wt % (such as at least 98 wt %, especially at least 99.5 wt %) ethylene monomer units. Typically, fraction (B) consists of a single ethylene copolymer. Fraction (A) may be considered to be an ethylene homopolymer mixture comprising (e.g. consisting of) a first ethylene homopolymer and a second ethylene homopolymer. Fraction (A) may be unimodal or multimodal.

The HDPE of the invention is produced in a multistage process wherein fractions (A) and (B) are produced in subsequent stages. In such a case, the properties of the fractions produced in the second step (or further steps) of the multistage process can either be inferred from polymers which are separately produced in a single stage by applying identical polymerisation conditions (e.g. identical temperature, partial pressures of the reactants/diluents, suspension medium, reaction time) with regard to the stage of the multistage process in which the fraction is produced, and by using a catalyst on which no previously produced polymer is present. Alternatively, the properties of the fractions produced in a higher stage of the multistage process may also be calculated, e.g. in accordance with B. Hagström, Conference on Polymer Processing (The Polymer Processing Society), Extended Abstracts and Final Programme, Gothenburg, Aug. 19 to 21, 1997, 4:13.

Thus, although not directly measurable on the multistage process products, the properties of the fractions produced in higher stages of such a multistage process can be determined by applying either or both of the above methods. The skilled person will be able to select the appropriate method.

Polymer HDPEs produced in a multistage process are also designated as “in-situ” blends. The resulting end product consists of an intimate mixture of the polymers from the two or more reactors, the different molecular-weight-distribution curves of these polymers together forming a molecular-weight-distribution curve having a broad maximum or two or more maxima, i.e. the end product is a multimodal polymer mixture

The lower molecular weight fraction (A) preferably has an MFR₂ of 10 g/10 min or higher, more preferably of 20 g/10 min or higher, and most preferably 30 g/10 min or higher.

Furthermore, fraction (A) preferably, has an MFR₂ of 500 g/10 min or lower, preferably 400 g/10 min or lower, and most preferably 300 g/10 min or lower.

Preferably, fraction (A) is an ethylene homopolymer with a density of at least 965 kg/m³.

Preferably, fraction (B) is an ethylene copolymer with a density of 920 to 960 kg/m³, such as 930 to 940 kg/m³.

Fraction (B) is a copolymer. Preferred ethylene copolymers employ alpha-olefins (e.g. C3-12 alpha-olefins) as comonomers. Examples of suitable alpha-olefins include but-1-ene, hex-1-ene and oct-1-ene. But-1-ene is an especially preferred comonomer.

As previously mentioned, in the particular aspect of the invention relating to the HDPE itself, fraction (B) is an ethylene butene copolymer.

It is preferred that compositions of the present invention have a shear thinning index (SHI 5/300, which is defined as the ratio of the viscosities at shear stresses of 5 and 300 kPa) of at least 45, preferably at least 50, more preferably at least 54, such as at least 55. The shear thinning index (SHI 5/300, which is defined as the ratio of the viscosities at shear stresses of 5 and 300 kPa) is ideally up 100, preferably up to 85, such as up to 75. The shear thinning index gives a measure of the processability of the material. In general, the higher the SHI value, the better the flowability and hence processability is improved.

### Polymerisation Process

The multimodal HDPE of the invention is prepared by a multistage polymerisation process comprising at least three polymerisation stages. In summary, the process comprises:
(i) polymerising ethylene in a first polymerisation stage in the presence of a Ziegler-Natta catalyst to prepare a first ethylene homopolymer;
(ii) polymerising ethylene in a second polymerisation stage in the presence of said catalyst and said first ethylene homopolymer to prepare an ethylene homopolymer mixture comprising said first ethylene homopolymer and a second ethylene homopolymer; and
(iii) polymerising ethylene and at least one alpha-olefin comonomer in a third polymerisation stage in the presence of said catalyst and said ethylene homopolymer mixture to prepare said multimodal HDPE; wherein the split for the third polymerisation stage is at least 50%.

### First and Second Polymerisation Stages

The first polymerisation stage produces a first ethylene homopolymer, which is subsequently fed to the second polymerisation stage. The second polymerisation stage produced a second ethylene homopolymer, thus generating an ethylene homopolymer mixture, which is subsequently fed to the third polymerisation stage.

The first and/or the second polymerisation stages are preferably slurry polymerization steps. More preferably, both the first and second polymerisation stages are slurry polymerisation steps.

The slurry polymerization usually takes place in an inert diluent, typically a hydrocarbon diluent such as methane, ethane, propane, n-butane, isobutane, pentanes, hexanes, heptanes, octanes etc., or their mixtures. Preferably the diluent is a low-boiling hydrocarbon having from 1 to 4 carbon atoms or a mixture of such hydrocarbons. An especially preferred diluent is propane, possibly containing minor amount of methane, ethane and/or butane.

The ethylene content in the fluid phase of the slurry may be from 1 to 50% by mole, preferably from 2 to 20% by mole and in particular from 2 to 10% by mole. The benefit of having a high ethylene concentration is that the productivity of the catalyst is increased but the drawback is that more ethylene then needs to be recycled than if the concentration was lower.

The temperature in each of the first and second polymerisation stages is typically from 60 to 100° C., preferably from 70 to 90° C. An excessively high temperature should be avoided to prevent partial dissolution of the polymer into the diluent and the fouling of the reactor. The pressure is from 1 to 150 bar, preferably from 40 to 80 bar.

The slurry polymerisation may be conducted in any known reactor used for slurry polymerization. Such reactors include a continuous stirred tank reactor and a loop reactor. It is especially preferred to conduct the slurry polymerization in a loop reactor. In such reactors the slurry is circulated with a high velocity along a closed pipe by using a circulation pump. Loop reactors are generally known in the art and examples are given, for instance, in U.S. Pat. Nos. 4,582,816, 3,405,109, 3,324,093, EP-A-479186 and U.S. Pat. No. 5,391,654. It is thus preferred to conduct the first and second polymerization stages as slurry polymerisations in two consecutive loop reactors.

The slurry may be withdrawn from each reactor either continuously or intermittently. A preferred way of intermittent withdrawal is the use of settling legs where slurry is allowed to concentrate before withdrawing a batch of the concentrated slurry from the reactor. The use of settling legs is disclosed, among others, in U.S. Pat. Nos. 3,374,211, 3,242,150 and EP-A-1310295. Continuous withdrawal is disclosed, among others, in EP-A-891990, EP-A-1415999, EP-A-1591460 and WO-A-2007/025640. The continuous withdrawal is advantageously combined with a suitable concentration method, as disclosed in EP-A-1310295 and EP-A-1591460. It is preferred to withdraw the slurry from each of the first and second polymerisation stages continuously.

Hydrogen is typically introduced into the first and second polymerisation stages for controlling the MFR₂ of the first and second ethylene homopolymers. The amount of hydrogen needed to reach the desired MFR depends on the catalyst used and the polymerisation conditions. The desired polymer properties may be obtained in slurry polymerisation in a loop reactor with the molar ratio of hydrogen to ethylene of from 100 to 1000 mol/kmol (or mol/1000 mol) and preferably of from 200 to 800 mol/kmol. Preferably, hydrogen is present in both the first and second polymerisation stages.

The average residence time in each of the first and second polymerisation stages is typically from 20 to 120 minutes, preferably from 30 to 80 minutes. As it is well known in the art the average residence time z can be calculated from Equation 1 below:

$$τ = \frac{{V}_{R}}{{Q}_{o}} \qquad Equation 1 \text{:} Residence Time$$

Where V_{R} is the volume of the reaction space (in case of a loop reactor, the volume of the reactor, in case of the fluidized bed reactor, the volume of the fluidized bed) and Qₒ is the volumetric flow rate of the product stream (including the polymer product and the fluid reaction mixture).

The production rate is suitably controlled with the catalyst feed rate. It is also possible to influence the production rate by suitable selection of the monomer concentration. The desired monomer concentration can then be achieved by suitably adjusting the ethylene feed rate.

According to the present invention, it is beneficial that the polymer, monomer and catalyst particles of the first and second polymerisation stages have a narrow distribution for the residence time. This is seen to pose advantages in view of the homogeneity of the particles, namely in view of a more homogenous catalyst activity when producing the ethylene copolymer in the subsequent third polymerisation stage, leading to a more even distribution of the ethylene copolymer in/around these particles, more predictable incorporation of the comonomer and a lower amount of easily extractable low-molecular-weight fractions.

Without being bound to any theory, the inventors believe that a certain minimum residence time in the first and second polymerisation stages influences the catalyst activity, such that densities and melt flow rates of the final polymer product may be more fine tuned.

So the present inventors have identified a way to create a more homogenous polymer fraction by splitting the production process into two consecutive polymerization stages. This split production mode leads to a more homogenous residence time of the particles prior to entry into the third polymerisation stage, hence more uniform properties of the particles produced therein, in terms of viscosity and density. These two properties, namely viscosity and density in combination, have a decisive influence on the final properties of the final multimodal HDPE and any articles produced thereof.

The first and second ethylene homopolymers may be unimodal in view of their molecular weight and/or their density or they can be bimodal in respect of their molecular weight and/or their density. However, it is preferred if they are unimodal in view of their molecular weight and density. Thus, the ethylene homopolymer mixture is preferably a unimodal mixture. For a person skilled in the art it will be clear that—when producing the first and the second ethylene homopolymers in two consecutive reactors, there can be a small difference in the MFR₂-values and density-values of each fraction, whilst still being considered “unimodal”.

The split between the first and second polymerisation stages may be in the range 30:70 to 70:30, preferably 40:60 to 60:40, such as 45:55 to 55:45, for example 50:50.

### Third Polymerisation Stage

In the third polymerisation stage, ethylene is polymerised together with at least one alpha-olefin comonomer, in the presence of the catalyst and the ethylene homopolymer mixture. It will thus be appreciated that the third polymerisation stage generates an ethylene copolymer, which combines with the ethylene homopolymer mixture to form the HDPE of the invention. Preferable comonomers are discussed hereinbefore, however it is noted that it is particularly preferable if the at least one alpha-olefin is butene.

The third polymerisation stage is preferably a gas phase polymerisation step, i.e. carried out in a gas-phase reactor. Any suitable gas phase reactor known in the art may be used, such as a fluidised bed gas phase reactor.

For gas phase reactors, the reaction temperature used will generally be in the range 60 to 115° C. (e.g. 70 to 110° C.), the reactor pressure will generally be in the range 10 to 25 bar, and the residence time will generally be 1 to 8 hours. The gas used will commonly be a non-reactive gas such as nitrogen or low boiling point hydrocarbons such as propane together with monomer (e.g. ethylene).

A chain transfer agent (e.g. hydrogen) is typically added to the third polymerisation stage, preferably in amounts of 50 to 500 mol of H₂/kmol ethylene. Preferably, hydrogen is present in the third polymerisation stage. Ideally, hydrogen in present in the first, second and third polymerisation stages.

The split between the third polymerisation stage and the first and second polymerisation stages taken together (i.e. between the gas phase polymerisation and the slurry polymerisations) is at least 50%, preferably 50 to 70%, such as 55 to 65%, e.g. 55 to 60%.

### Prepolymerization

The polymerization steps discussed above may be preceded by a prepolymerization step. The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step is conducted in slurry.

Thus, the prepolymerization step may be conducted in a loop reactor. The prepolymerization is then preferably conducted in an inert diluent, typically a hydrocarbon diluent such as methane, ethane, propane, n-butane, isobutane, pentanes, hexanes, heptanes, octanes etc., or their mixtures. Preferably the diluent is a low-boiling hydrocarbon having from 1 to 4 carbon atoms or a mixture of such hydrocarbons.

The temperature in the prepolymerization step is typically from 0 to 90° C., preferably from 20 to 80° C. and more preferably from 55 to 75° C.

The pressure is not critical and is typically from 1 to 150 bar, preferably from 40 to 80 bar.

The amount of monomer is typically such that from 0.1 to 1000 grams of monomer per one gram of solid catalyst component is polymerized in the prepolymerization step. As the person skilled in the art knows, the catalyst particles recovered from a continuous prepolymerization reactor do not all contain the same amount of prepolymer. Instead, each particle has its own characteristic amount which depends on the residence time of that particle in the prepolymerization reactor. As some particles remain in the reactor for a relatively long time and some for a relatively short time, then also the amount of prepolymer on different particles is different and some individual particles may contain an amount of prepolymer which is outside the above limits. However, the average amount of prepolymer on the catalyst typically is within the limits specified above.

The molecular weight of the prepolymer may be controlled by hydrogen as it is known in the art. Further, antistatic additives may be used to prevent the particles from adhering to each other or the walls of the reactor, as disclosed in WO-A-96/19503 and WO-A-96/32420.

The catalyst components are preferably all introduced to the prepolymerization step when a prepolymerization step is present. However, where the solid catalyst component and the cocatalyst can be fed separately it is possible that only a part of the cocatalyst is introduced into the prepolymerization stage and the remaining part into subsequent polymerization stages. Also in such cases it is necessary to introduce so much cocatalyst into the prepolymerization stage that a sufficient polymerization reaction is obtained therein.

It is understood within the scope of the invention, that the amount of polymer produced in the prepolymerization typically lies within 1-5 wt % in respect to the final multimodal HDPE.

### Catalyst

The polymerization is conducted in the presence of a Ziegler-Natta polymerization catalyst. Suitable Ziegler-Natta (ZN) catalysts generally comprise at least a catalyst component formed from a transition metal compound of Group 4 to 6 of the Periodic Table (IUPAC, Nomenclature of Inorganic Chemistry, 1989), a metal compound of Group 1 to 3 of the Periodic Table (IUPAC), optionally a compound of group 13 of the Periodic Table (IUPAC), and optionally an internal organic compound, like an internal electron donor. A ZN catalyst may also comprise further catalyst component(s), such as a cocatalyst and optionally external additives.

Suitable ZN catalysts preferably contain a magnesium compound, an aluminium compound and a titanium compound supported on a particulate support. The particulate support can be an inorganic oxide support, such as silica, alumina, titania, silica-alumina, silica-titania or a MgCl2 based support. Preferably, the support is silica or a MgCl2 based support.

Particularly preferred Ziegler-Natta catalysts are such as described in EP 1378528 A1.

If used, the magnesium compound preferably is a reaction product of a magnesium dialkyl and an alcohol. The alcohol is a linear or branched aliphatic monoalcohol. Preferably, the alcohol has from 6 to 16 carbon atoms. Branched alcohols are especially preferred, and 2-ethyl-1-hexanol is one example of the preferred alcohols. The magnesium dialkyl may be any compound of magnesium bonding to two alkyl groups, which may be the same or different. Butyl-octyl magnesium is one example of the preferred magnesium dialkyls.

The aluminium compound is a chlorine containing aluminium alkyl. Especially preferred compounds are aluminium alkyl dichlorides and aluminium alkyl sesquichlorides.

The transition metal compound of Group 4 to 6 is preferably a titanium or vanadium compound, more preferably a halogen containing titanium compound, most preferably chlorine containing titanium compound. Especially preferred titanium compound is titanium tetrachloride.

The catalyst can be prepared by sequentially contacting the carrier with the above mentioned compounds, as described in EP 688794 or WO 99/51646. Alternatively, it can be prepared by first preparing a solution from the components and then contacting the solution with a carrier, as described in WO 01/55230.

Another group of suitable ZN catalysts contain a titanium compound together with a magnesium halide compound acting as a support. Thus, the catalyst contains a titanium compound and optionally a Group 13 compound for example an aluminium compound on a magnesium dihalide, like magnesium dichloride. Such catalysts are disclosed, for instance, in WO 2005/118655, EP 810235, WO 2014/096296 and WO 2016/097193.

Suitable activators are group 13 metal compounds, typically group 13 alkyl compounds and especially aluminium alkyl compounds, where the alkyl group contains 1 to 16 C-atoms. These compounds include trialkyl aluminium compounds, such as trimethylaluminium, triethylaluminium, tri-isobutylaluminium, trihexylaluminium and tri-n-octylaluminium, alkyl aluminium halides, such as ethylaluminium dichloride, diethylaluminium chloride, ethylaluminium sesquichloride, dimethylaluminium chloride and the like. Especially preferred activators are trialkylaluminiums, of which triethylaluminium, trimethylaluminium and tri-isobutylaluminium are particularly used.

The amount in which the activator is used depends on the specific catalyst and activator. Typically triethylaluminium is used in such amount that the molar ratio of aluminium to the transition metal, like Al/Ti, is from 1 to 1000, preferably from 3 to 100 and in particular from about 5 to about 30 mol/mol.

An optional internal organic compound may be chosen from the following classes: ethers, esters, amines, ketones, alcohols, anhydrides or nitriles or mixtures thereof. Preferably, the optional internal organic compound is selected from ethers and esters, most preferably from ethers. Preferred ethers are of 2 to 20 carbon-atoms and especially mono, di or multi cyclic saturated or unsaturated ethers comprising 3 to 6 ring atoms. Typical cyclic ethers suitable in the present invention, if used, are tetrahydrofuran (THF), substituted THF, like 2-methyl THF, di-cyclic ethers, like 2,2-di(2-tetrahydrofuryl)propane, 2,2-di-(2-furan)-propane, or isomers or mixtures thereof. Internal organic compounds are also often called as internal electron donors.

In the production of the multimodal HDPE of the present invention, preferably a compounding step is applied, wherein the composition of the base resin, i.e. the blend, which is typically obtained as a base resin powder from the reactor, is extruded in an extruder and then pelletised to polymer pellets in a manner known in the art.

The polyethylene composition may also contain minor quantities of additives such as pigments, nucleating agents, antistatic agents, fillers, antioxidants, etc., generally in amounts of up to 10% by weight, preferably up to 5% by weight.

Optionally, additives or other polymer components can be added to the composition during the compounding step in the amount as described above. Preferably, the composition of the invention obtained from the reactor is compounded in the extruder together with additives in a manner known in the art.

The multimodal HDPE of the invention may also be combined with other polymer components such as other polymers of the invention, with other HDPEs or with other polymers such as LLDPE or LDPE. However, the films of the invention are preferably at least 75 wt %, such as at least 90 wt % of the polymer of the invention, such as at least 95 wt %. In one embodiment, the films consist essentially of the HDPE polymer of the invention. The term consists essentially of means that the polymer of the invention is the only “non additive” polyolefin present. It will be appreciated however that such a polymer may contain standard polymer additives some of which might be supported on a polyolefin (a so called masterbatch as is well known in the art). The term consists essentially of does not exclude the presence of such a supported additive.

### Films

Still further, the present invention relates to a film comprising the HDPE as described above and to the use of such a polyethylene composition in the manufacture of a film.

Preferably, the film comprises at least 90.0 wt % of the HDPE, more preferably at least 95.0 wt %, still more preferably at least 98.0 wt %, like at least 99.9 wt %. It is especially preferred that the film consists of the HDPE.

Films comprising the HDPE according to the present invention can be produced with several known conversion techniques, such as extrusion via blown or cast film technology, wherein blown films are preferred.

Films according to the present invention may also be subjected to post-treatment processes, e.g. lamination or orientation processes. Such orientation processes can be mono-axially (MDO) or bi-axially orientation, wherein mono-axial orientation is preferred.

Films comprising, preferably consisting of, the HDPE of the invention are preferably blown films, shrink films, collation shrink films, wrap films, lamination films, etc. The films according to the present invention are highly useful to being used in various packaging applications or for producing packaging articles, wherein applications related to food packaging are preferred. Packaging articles comprising the HDPE of the current invention comprise bags, pouches, wrapping or collation films, and the like.

The film will typically have a thickness in the range of 2 to 50 μm, preferably in the range of 5 to 25 μm, like in the range of 7 to 15 μm.

The films of the invention may be multilayer or monolayer films.

Preferably, the film has a haze determined according to ASTM D 1003-00 measured on a 15 μm blown film in the range 50 to 95%, such as 70 to 90%

Further, it is preferred that the film has a tensile modulus determined according to ISO 527-3 on 15 μm films in machine direction (MD) and/or transverse direction (TD) of at least 500 MPa, more preferably in the range of 600 to 1500 MPa, still more preferably in the range of 700 to 1400 MPa.

Additionally, it is preferred that the film has a dart-drop strength (DDI) determined according to ASTM D1709, method A on a 15 μm blown film of at least 100 g, more preferably in the range of 100 to 600 g, still more preferably in the range of 150 to 500 g, like in the range of 200 to 400 g.

It is further preferred that the film has a high Elmendorf tear strength as determined in accordance with ISO 6383/2. As measured in machine direction (MD) at a film thickness of 15 μm, the tear strength is preferably at least 2.0 N/mm, more preferably in the range of 3.0 to 20.0 N/mm, like in the range of 5.0 to 15.0 N/mm. As measured in transverse direction (TD) at a film thickness of 15 μm, the tear strength is preferably at least 15.0 N/mm, more preferably in the range of 15.0 to 500 N/mm, like in the range of 20.0 to 300 N/mm.

In embodiments wherein the film is a blown film, the film may be produced using an extrusion blown process as known in the art is applied. The film of the present invention is preferably produced by first extruding the HDPE through a circular die, followed by “bubble-like” expansion. The blown film according to this invention is for example produced on a single screw extruder with a barrel diameter of 70 mm and a round-section die of 200 mm with 1 2 mm die gap in combination with a monolip cooling ring and internal bubble cooling (IBC). Melt temperature is preferably 210° C. in the die; the temperature of the cooling air is kept preferably at 15° C. and the blow up ratio (BUR) is preferably of 1:1.5 or less. More preferably, a typical blow up ratio (BUR) of the inventive blown film is 1:1.5 to 1:5, still more preferably the blow-up ratio is 1:2 to 1:4. Moreover it is preferred that a film thickness is adjusted through the ratio between extruder output, takeoff speed and blow up ratio (BUR).

It will be appreciated that any parameter mentioned above is measured according to the detailed test given below. In any parameter where a narrower and broader embodiment are disclosed, those embodiments are disclosed in connection with the narrower and broader embodiments of other parameters.

The invention will now be described with reference to the following non limiting examples.

### Test Methods:

### Melt Flow Rate

The melt flow rate (MFR) is determined according to ISO 1133 and is indicated in g/10 min. The MFR is an indication of the melt viscosity of the polymer. The MFR is determined at 190° C. for PE. The load under which the melt flow rate is determined is usually indicated as a subscript, for instance MFR₂ is measured under 2.16 kg load (condition D), MFR₅ is measured under 5 kg load (condition T) or MFR₂₁ is measured under 21.6 kg load (condition G).

FRR is determined as the ratio between Melt Flow Rates at different loadings.

The FRR 21/5 is the ratio between MFR₂₁ and the MFR₅

The FRR 21/2 is the ratio between MFR₂₁ and the MFR₂

### Density

Density of the polymer was measured according to ISO 1183/1872-2B.

For the purpose of this invention the density of the blend can be calculated from the densities of the components according to:

$${ρ}_{b} = {\sum }_{i} {w}_{i} \cdot {ρ}_{i}$$

where ρ_{b} is the density of the blend,
wᵢ is the weight fraction of component “i” in the blend and
ρᵢ is the density of the component “i”.

### Molecular Weight

Molecular Weight Averages, Molecular Weight Distribution (Mn, Mw, Mz MWD)

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-1:2003, ISO 16014-2:2003, ISO 16014-4:2003 and ASTM D 6474-12 using the following formulas:

$${M}_{n} = \frac{{\sum }_{i = 1}^{N} {A}_{i}}{{\sum }_{i = 1}^{N} ( \frac{{A}_{i}}{{M}_{i}} )} \qquad ( 1 )$$

$${M}_{w} = \frac{{{\sum }_{i = 1}^{N} [ ( A ]}_{i} \times {M}_{i} )}{{\sum }_{i = 1}^{N} {A}_{i}} \qquad ( 2 )$$

$${M}_{z} = \frac{{{\sum }_{i = 1}^{N} [ ( A ]}_{i} \times {M}_{i}^{2} )}{{\sum }_{i = 1}^{N} ( \frac{{A}_{i}}{{M}_{i}} )} \qquad ( 3 )$$

For a constant elution volume interval ΔVᵢ, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain) or differential refractometer (RI) from Agilent Technologies, equipped with 3× Agilent-PLgel Olexis and 1× Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. and at a constant flow rate of 1 mL/min. 200 μL of sample solution was injected per analysis. Data collection was performed using either Agilent Cirrus software version 3.3 or PolymerChar GPC-IR control software.

The column set was calibrated using universal calibration (according to ISO 16014-2:2003) with 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:
K_{PS}=19×10⁻³ mL/g, α_{PS}=0.655
K_{PE}=39×10⁻³ mL/g, α_{PE}=0.725
K_{PP}=19×10⁻³ mL/g, α_{PP}=0.725

A third order polynomial fit was used to fit the calibration data.

All samples were prepared in the concentration range of 0.5-1 mg/ml and dissolved at 160° C. for 2.5 hours for PP or 3 hours for PE under continuous gentle shaking.

Melt Pressure is available as a reading output, visible on the control screen of the blown film line.

### Dart Drop Impact

Dart-drop is measured using ASTM D1709, method A (Alternative Testing Technique) from the film samples. A dart with a 38 mm diameter hemispherical head is dropped from a height of 0.66 m onto a film clamped over a hole. Successive sets of twenty specimens are tested. One weight is used for each set and the weight is increased (or decreased) from set to set by uniform increments. The weight resulting in failure of 50% of the specimens is calculated and reported.

### Tensile Properties

Tensile properties were measured according to ISO 527-3 on films with a thickness of 15 μm and a film width of 15 mm at a temperature of 23° C.

Tensile modulus in the machine direction was determined at a cross-head speed of 1 mm/min 0.05-0.25% of elongation.

Tensile strain at break and tensile strength are determined at a test speed of 200 mm/min.

### Notched Impact Strength (NIS)

The Charpy notched impact strength (NIS) was measured according to ISO 179 1eA at +23° C., using injection moulded bar

### OCS Gels Measurement

Gel content was analyzed by an Optical Control System (OCS Film-Test FSA100) with a CCD (Charged-Coupled Device) camera provided by Optical Control Systems GmbH, which measures gels and defects in the film produced from the compositions. The gels and defects are recognized optoelectronically by their different light transmittance compared to the film matrix. A translucent 70 m thick cast film was photographed using high resolution line cameras and appropriate background illumination. The number and the area of gels per total film area are then calculated using an image recognition software. The film defects/gels are measured and classified according to their size (longest dimension).

Cast Film Preparation, Extrusion Parameters:
1. Output 25±4 g/min
2. Extruder temperature profile 200/210/220/220/220-Die
3. Film thickness about 70 m
4. Chill Roll temperature 20° C.
5. Air knife needed

Technical Data for the Extruder:
1. Screw type: 3 Zone, nitrated
2. Screw diameter: 25 mm
3. Screw length: 25D
4. Feeding zone: 10D
5. Compression zone: 4D
6. Die 150 mm

The defects were classified according to the size (μm)/m2:
100-299
300-599
600-999
>1000

### Tear Resistance (Determined as Elmendorf Tear (N) in Machine (MD) and Transverse (TD) Direction:

The tear strength is measured using the ISO 6383/2 method. The force required to propagate tearing across a film sample is measured using a pendulum device. The pendulum swings under gravity through an arc, tearing the specimen from pre-cut slit. The specimen is fixed on one side by the pendulum and on the other side by a stationary clamp. The tear resistance is the force required to tear the specimen. The relative tear resistance (N/mm) is then calculated by dividing the tear resistance by the thickness of the film.

### Protrusion Puncture Resistance

This method determines the resistance of a film to the penetration of a specimen at a standard low rate, a single test velocity. The test is carried out at a temperature of 23° C., a test speed of 250 mm/min.

### Haze

Standard test method (Method A—Hazemeter) for determination of transparency properties according ASTM D1003 on film at a thickness of 15 m.

### Rheological Measurements

### Determination of SHI (2.7/210)

The rheology of polymers are determined using Anton Paar MCR 501 Rheometer. The measurement is carried out using a compression-molded disc of polymer sample. The disc has a thickness of about 2 mm and a diameter of 26 mm. The disk is loaded and heated at a measured temperature of 190° C. under nitrogen atmosphere. The molten polymer sample is then kept at 190° C. for 5 minutes to achieve a homogenous melting. A frequency sweep is conducted from 628 rad/s to 0.01 rad/s. The measurement is logarithmically set at 5 measurement points per decade. The plate-plate geometry of 25 mm diameter, a gap of 1.3 mm (trimming position at 1.4 mm) and the strain was within the linear viscoelastic range typically <10%. The measurements give storage modulus (G′) and loss modulus (G″) together with absolute value of complex viscosity (η*) as a function of frequency (ω) or absolute value of complex modulus (G*).

η*=r(G′²+G″²)/ω

G*=(G′²+G″²)

According to Cox-Merz rule complex viscosity function, η*(ω) is the same as conventional viscosity function (viscosity as a function of shear rate), if frequency is taken in rad/s. If this empiric equation is valid absolute value of complex modulus corresponds shear stress in conventional (that is steady state) viscosity measurements. This means that function η* (G*) is the same as viscosity as a function of shear stress.

In the present method viscosity at a low shear stress or η* at a low G* (which serve as an approximation of so-called zero viscosity) is used as a measure of average molecular weight. On the other hand, shear thinning, that is the decrease of viscosity with G*, gets more pronounced the broader is molecular weight distribution. This property can be approximated by defining a so-called shear thinning index, SHI, as a ratio of viscosities at two different shear stresses. In the examples below the shear modulus (or G*) 2.7 kPa and 210 kPa have been used. Thus:

SHI_{2.7/210}=η*_{2.7}/η*₂₁₀

wherein
η*_{2.7} is complex viscosity at G*=2.7 kPa and
η*₂₁₀ is complex viscosity at G*=210 kPa

### Determination of SHI (5/300)

SHI_{5/300}=η*₅/η*₃₀₀
η*₅ is complex viscosity at G*=5.0 kPa and
η*₃₀₀ is complex viscosity at G*=300 kPa

As the G* at 300 kPa is out of the experimental range, an extrapolation of G* at 300 kPa is needed. This is done by using the Rheoplus software developed by Anton Paar. The interpolation type is logarithmic based on the following formulation:

Log(y)=log(yi)+(log(x)−log(xi))x(log(yii)−log(yi))/(log(xii)−log(xi))
y is the complex viscosity η* in Pa·s and
x is the complex shear modulus G* in Pa

To calculate η*₃₀₀, the extrapolation of G* to 300 kPa is determined based on the two points of angular frequency at 0.0100 and 0.0158 rad/s.

yi and yii are the two points of η* and xi and xii are the G* values at the two points of angular frequency of 0.0100 and 0.0158 rad/s. The yi, yii, xi and xii data points are available from the experiment. In order to limit the error from extrapolation, the calculation is only limited within 10% of G* value of the last experimental point.

### EXPERIMENTAL

### Catalyst Preparation

Catalyst component used in (co)polymerization of ethylene in the inventive examples is Lynx 200, which is a commercially available Ziegler-Natta catalyst manufactured and supplied by Grace Catalysts Technologies.

### Preparation of Polymers

Polyethylene base resins and compositions according to the invention (IE1-IE6) were produced using Lynx 200 catalyst.

### Production of the Multimodal HDPE of the Invention (IE1-IE6)

### IE1:

A loop reactor having a volume of 50 dm³ was operated at a temperature of 60° C. and a pressure of 56 bar. Into the reactor were fed ethylene, propane diluent and hydrogen. Also a solid polymerization catalyst component Lynx 200 was introduced into the reactor together with triethylaluminium cocatalyst so that the molar ratio of A/Ti was about 15 mol/mol. The estimated production split was 2 wt %.

A stream of slurry was continuously withdrawn and directed to a loop reactor having a volume of 150 dm³ and which was operated at a temperature of 95° C. and a pressure of 54.5 bar. Into the reactor were further fed additional ethylene, propane diluent and hydrogen so that the ethylene concentration in the fluid mixture was 2.1% by mole and the hydrogen to ethylene ratio was 648 mol/kmol. The estimated production split was 15 wt %. The ethylene homopolymer withdrawn from the reactor had MFR₂ of 32 g/10 min.

A stream of slurry from the reactor was withdrawn intermittently and directed into a loop reactor having a volume of 350 dm³ and which was operated at 95° C. temperature and 53 bar pressure. Into the reactor was further added a fresh propane, ethylene, and hydrogen so that the ethylene concentration in the fluid mixture was 3.3 mol % and the molar ratio of hydrogen to ethylene was 658 mol/kmol. The ethylene homopolymer withdrawn from the reactor had MFR₂ of 245 g/10 min and density of 970.6 kg/m³. The estimated production split was 26 wt %.

The slurry was withdrawn from the loop reactor intermittently and directed to a flash vessel operated at a temperature of 50° C. and a pressure of 3 bar. From there the polymer was directed to a fluidized bed gas phase reactor operated at a pressure of 20 bar and a temperature of 85° C. Additional ethylene and 1-butene comonomer, nitrogen as inert gas and hydrogen were added so that the molar ratio of hydrogen to ethylene was 47 mol/kmol and the molar ratio of 1-butene to ethylene was 32 mol/kmol. The estimated production split was 57 wt %. The polymer had a melt flow rate MFR₅ of 0.21 g/10 min and a density of 951.4 kg/m³.

The procedure of IE1 was repeated for IE2-IE6 by adapting reactor conditions as described in Table 1.

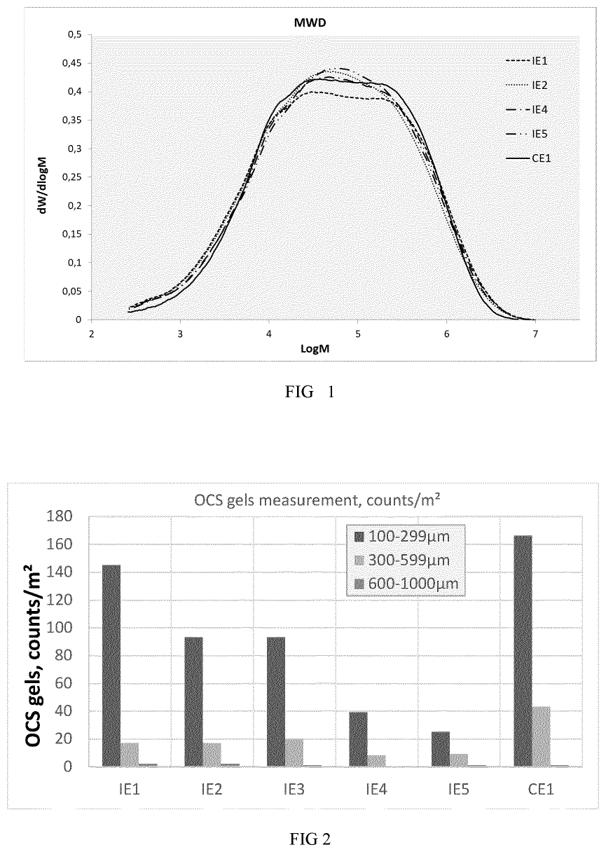

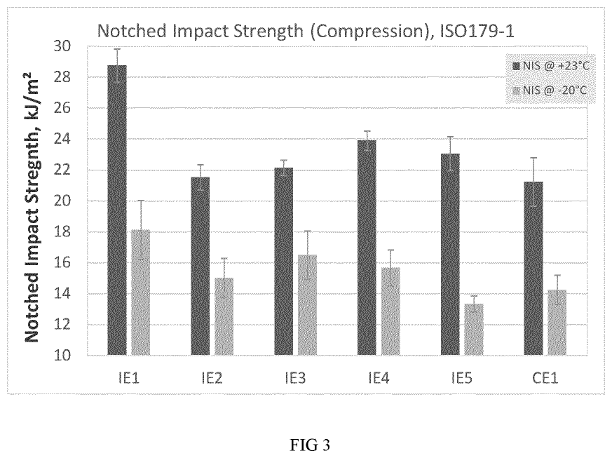

Properties of the various fractions and final HDPE are also presented in Table 1. Molecular weight data are shown in Table 3 and FIG. 1. Other properties of the HDPEs produced are presented in Tables 4 and 5. Gel results are shown in FIG. 2 and Notched Impact results in FIG. 3.

TABLE 1
Production Data for Inventive HDPE

| | | | | | |
|---|---|---|---|---|---|
| IE1 | IE2 | IE3 | IE4 | IE5 | IE6 |

Prepoly. reactor

| | | | | | | |
|---|---|---|---|---|---|---|
| Temp. (° C.) | 60 | 60 | 60 | 60 | 60 | 50 |
| Press. (kPa) | 5631 | 5615 | 5653 | 5661 | 5638 | 5666 |
| Split (wt %) | 2 | 2 | 2 | 2 | 2 | 2 |

1^{st} loop reactor

| | | | | | | |
|---|---|---|---|---|---|---|
| Temp. (° C.) | 95 | 95 | 95 | 95 | 95 | 95 |
| Press. (kPa) | 5462 | 5447 | 5452 | 5442 | 5446 | 5484 |
| Ethylene conc. (mol-%) | 2.1 | 2.3 | 2.4 | 2.2 | 2.0 | 3.0 |
| H₂/C₂ ratio (mol/kmol) | 648 | 569 | 593 | 655 | 410 | 610 |
| Split (wt. %) | 15 | 15 | 15 | 16 | 18 | 20 |
| MFR2 (g/10 min) | 32 | 131 | 150 | 200 | 48 | 230 |

2^{nd} loop reactor

| | | | | | | |
|---|---|---|---|---|---|---|
| Temp. (° C.) | 95 | 95 | 95 | 95 | 95 | 95 |
| Press. (kPa) | 5293 | 5272 | 5275 | 5273 | 5276 | 5276 |
| Ethylene conc. (mol-%) | 3.3 | 2.8 | 3.1 | 2.8 | 2.5 | 3.3 |
| H₂/C₂ ratio (mol/kmol) | 658 | 566 | 534 | 587 | 799 | 680 |
| Split (wt. %) | 26 | 25 | 23 | 25 | 23 | 20 |
| MFR2 (g/10 min) | 245 | 252 | 208 | 210 | 192 | 293 |
| Density (kg/m3) | 970.6 | | | | 970.8 | 971.6 |

Gas phase reactor

| | | | | | | |
|---|---|---|---|---|---|---|
| Temp. (° C.) | 85 | 95 | 95 | 85 | 85 | 90 |
| Press. (kPa) | 2000 | 2000 | 2000 | 2000 | 2000 | 2000 |
| H₂/C₂ ratio (mol/kmol) | 47 | 53 | 59 | 68 | 71 | 50 |
| C₄/C₂ ratio (mol/kmol) | 32 | 23 | 20 | 30 | 30 | 27 |
| Split (wt. %) | 57 | 58 | 60 | 57 | 57 | 58 |

Pellet

| | | | | | | |
|---|---|---|---|---|---|---|
| MFR2 (g/10 min) | | | | 0.07 | | 0.07 |
| MFR5 (g/10 min) | 0.21 | 0.29 | 0.3 | 0.27 | 0.3 | 0.29 |
| MFR21 (g/10 min) | 7.0 | 8.6 | 7.3 | 7.1 | 7.9 | 7.69 |
| Density (kg/m3) | 951.4 | 952.8 | 952.9 | 952.0 | 951.3 | 952.9 |
| FRR (21/5) | 33.3 | 29.6 | 24.2 | 26.1 | 26.5 | 26.5 |

### Comparative HDPE (CE1)

Comparative Example 1 (CE1) is a commercially available polyethylene composition FB 1520 from Borouge Pte Ltd. Properties are shown in Table 2. Molecular weight data are shown in Table 3 and FIG. 1. Other properties of the HDPEs produced are presented in Tables 4 and 5. Gel results are shown in FIG. 2 and Notched Impact results in FIG. 3.

TABLE 2
Properties of Comparative HDPE

| Pellet | CE1 |
|---|---|
| Density, kg/m³ | 953.2 |
| MFR₂, g/10 min. | 0.09 |
| MFR₅, g/10 min. | 0.27 |
| MFR₂₁, g/10 min | 8.0 |
| FRR (21/5) | 29.5 |

TABLE 3
Molecular weight data

| | Mn (Da) | Mw (Da) | Mz (Da) | Mw/Mn | Mz/Mw |
|---|---|---|---|---|---|
| IE1 | 8695 | 252500 | 1315000 | 29.1 | 5.2 |
| IE2 | 8880 | 221000 | 1205000 | 24.9 | 5.5 |
| IE3 | 9440 | 223000 | 1205000 | 23.6 | 5.4 |
| IE4 | 9390 | 240500 | 1270000 | 25.6 | 5.3 |
| IE5 | 9290 | 233500 | 1245000 | 25.2 | 5.3 |
| IE6 | 9030 | 246500 | 1450000 | 27.3 | 5.9 |
| CE1 | 10900 | 222000 | 981000 | 20.4 | 4.4 |

TABLE 4
Melt Pressure data

| | Melt pressure at Collin BF30, bar | | | | | |
|---|---|---|---|---|---|---|
| | CE1 | IE1 | IE2 | IE3 | IE4 | IE5 |
| 15 μm, BUR 1:3, | 360 | 357 | 349 | 365 | 362 | 384 |
| Neck 4D | | | | | | |
| 20 μm, BUR 1:4, | 371 | 361 | 351 | 363 | 365 | 384 |
| Neck 4D | | | | | | |

TABLE 5
Mechanical data

| | CE1 | IE1 | IE2 | IE3 | IE4 | IE5 |
|---|---|---|---|---|---|---|
| DDI @ 15 μm | 132 | 180 | 212 | 161 | 157 | |
| (BUR 1:3, neck-height 4xDD) | | | | | | |
| DDI @ 20 μm | 117 | 214 | 161 | 182 | | 160 |
| (BUR 1:4, neck-height 4xDD) | | | | | | |
| Tensile Modulus, MPa | 894 | 882 | 884 | 939 | 863 | 828 |
| Tensile Strength, MPa | 74.8 | 82.9 | 73.7 | 84.4 | 84.8 | 83.5 |
| Tensile Strain @ Break, % | 292 | 314 | 376 | 343 | 323 | 320 |

### Production of Films

A cast film of IE6 was produced using an extruder with a melt temperature of 221° C. The same process was used to prepare a cast film from the Comparative Example (CE1). Gels were measured using the procedure described above, the results are shown in Table 6.

TABLE 6
Gel OCS measurement on cast film

| | IE6 | CE1 |
|---|---|---|
| Gels counts (pieces/m²), 100-299 μm | 361 | 657 |
| Gels counts (pieces/m²), 300-599 μm | 20 | 106 |
| Gels counts (pieces/m²), 600-1000 μm | 0 | 3 |
| Gels counts (pieces/m²), >1000 μm | 0 | 0 |

A Blown film of IE6 was produced at Alpine-Hosokawa mono-extruder (105 mm screw diameter, 30D) high-neck blown film line: the blowing head with a die diameter of 225 mm and a die gap of 1.2 mm, BUR 1:4, Neck height 9×DD with internal bubble cooling (IBC). The extrusion temperature was set at 220° C./225° C./225° C./225° C./225° C., die temperature was 220° C., and the blowing head temperature of 230° C. The output was at 225 kg/hr. Two different film thicknesses were produced: 15 and 7 m. The Frost Line Height (FLH) was about 2300 mm. The same process was used to prepare a blown film from the Comparative Example (CE1). The properties of the blown films are shown in Tables 7 to 10.

TABLE 7
Processing data

| | IE6 | | CE1 | |
|---|---|---|---|---|
| Film thickness (μm) | 7 | 15 | 7 | 15 |
| Thickness variation (%) | 22 | 22 | 25 | 37 |
| Melt pressure Sieve (bar) | 489 | 489 | 523 | 523 |
| Output (kg/h) | 224.9 | 225 | 224.9 | 225 |
| Specific Energy Input (kWh/kg) | 0.37 | 0.42 | — | 0.58 |

TABLE 8
Mechanical Properties at 15 μm film thickness

| | IE6 | CE1 |
|---|---|---|
| Tensile Modulus MD/TD (MPa) | 828/1209 | 862/1227 |
| Tensile Stress at Yield MD/TD (MPa) | 24.8/28.2 | 25.7/25.4 |
| Tensile Strength MD/TD (MPa) | 69.9/59.9 | 69.4/90.6 |
| Tensile Stress at Break MD/TD (MPa) | 69.3/53.7 | 69.1/54.5 |
| Tensile Elongation at Break MD/TD (MPa) | 322/510 | 366/484 |
| Dart Drop Impact (g) | 256 | 312 |
| Protrusion Puncture Resistance, Force (N)/ | 27.3/0.70 | 22.7/0.58 |
| Energy (J) | | |
| Haze (%) | 83 | 87 |

TABLE 9
Tear Resistance

| | |
|---|---|
| IE6 | CE1 |

15 μm film thickness

| | | |
|---|---|---|
| Tear Elmendorf resistance MD/TD | 5.2/111.6 | not available, |
| (N/mm) | | due to big |
| Tear Elmendorf resistance MD/TD | 0.93/2.10 | thickness |
| (N) | | variation |

7 μm film thickness

| | | |
|---|---|---|
| Tear Elmendorf resistance MD/TD | 6.3/84.5 | 5.0/81.9 |
| (N/mm) | | |
| Tear Elmendorf resistance MD/TD | 0.54/1.50 | 0.46/1.59 |
| (N) | | |

TABLE 10
Rheology data

| | CE1 | IE1 | IE2 | IE3 | IE4 | IE5 | IE6 |
|---|---|---|---|---|---|---|---|
| PI, 1/Pa | 2.16 | 2.45 | 2.11 | 2.33 | 2.32 | 2.27 | 2.25 |
| Eta(0.05 rad/s) Pa · s | 124622 | 173739 | 115968 | 125240 | 127852 | 116628 | 128295 |
| Eta(300 rad/s) Pa · s | 1308 | 1360 | 1308 | 1273 | 1274 | 1253 | 1297 |
| SHI (2.7/210) | 31.49 | | 30.65 | 35.98 | 35.05 | 34.49 | 33.48 |
| SHI (5/300) | 54 | 71.8 | 50.7 | 61.5 | 61.6 | 58.6 | 57.98 |
| Eta(2.7 kPa) Pa · s | 169309 | | 154139 | 174961 | 177641 | 156945 | 177263 |
| Eta(5 kPa) Pa · s | 135424 | 221928 | 122288 | 137129 | 140883 | 123352 | 141366 |

1. A process for the preparation of a multimodal high density polyethylene (HDPE) having a density of greater than 950 kg/m³, a Mz of at least 1000 kDa and a melt flow rate (MFR₅) of 0.01 to 4.0 g/10 min, said process comprising:
(i) polymerising ethylene in a first polymerisation stage in the presence of a Ziegler-Natta catalyst to prepare a first ethylene homopolymer;
(ii) polymerising ethylene in a second polymerisation stage in the presence of said catalyst and said first ethylene homopolymer to prepare an ethylene homopolymer mixture comprising said first ethylene homopolymer and a second ethylene homopolymer; and
(iii) polymerising ethylene and at least one alpha-olefin comonomer in a third polymerisation stage in the presence of said catalyst and said ethylene homopolymer mixture to prepare said multimodal HDPE;
wherein the split for the third polymerisation stage is at least 50%.

2. The process as claimed in claim 1, wherein the HDPE has a MFR₂₁ of 2.5 to 12 g/10 min.

3. The process as claimed in claim 1, wherein the HDPE has a MFR₂ of less than 0.1 g/10 min.

4. The process as claimed in claim 1, wherein said first polymerisation stage and/or said second polymerisation stage are carried out in a slurry loop reactor.

5. The process as claimed in claim 1, wherein said third polymerisation stage is carried out in a gas phase reactor.

6. The process as claimed in claim 1, wherein the split for the third polymerisation stage is 55 to 65%.

7. The process as claimed in claim 1, wherein said at least one alpha-olefin has 3 to 12 carbon atoms.

8. The process as claimed in claim 1, wherein the HDPE has a density of 951 to 960 kg/m³.

9. The process as claimed in claim 1, wherein the HDPE has a MFR₂ of 0.01 to 0.095 g/10 min.

10. The process as claimed in claim 1, wherein the HDPE has a molecular weight distribution (Mw/Mn) of greater than 21.

11. A multimodal high density polyethylene (HDPE) having a density of greater than 950 kg/m³, a Mz of at least 1000 kDa and a melt flow rate (MFR₅) of 0.01 to 4.0 g/10 min obtained by a process as defined in claim 1.

12. A multimodal high density polyethylene (HDPE) having a density of greater than 950 kg/m³, a Mz of at least 1000 kDa and a melt flow rate (MFR₅) of 0.01 to 4.0 g/10 min, wherein said HDPE comprises a low molecular weight ethylene homopolymer component and a high molecular weight ethylene-butene copolymer component.

13. The multimodal HDPE as claimed in claim 12, wherein said low molecular weight ethylene homopolymer component is an ethylene homopolymer mixture comprising a first ethylene homopolymer and a second ethylene homopolymer.

14. A film, comprising a multimodal HDPE having a density of greater than 950 kg/m³, a Mz of at least 1000 kDa and a melt flow rate (MFR₅) of 0.01 to 4.0 g/10 min, wherein said HDPE comprises a low molecular weight ethylene homopolymer component and at least 50 wt % of a high molecular weight ethylene copolymer component, relative to the total weight of the HDPE.

15. The film as claimed in claim 14, wherein the HDPE 55 to 65 wt % of the high molecular weight ethylene copolymer component, relative to the total weight of the HDPE.

16. The film as claimed in claim 14, wherein said low molecular weight ethylene homopolymer component is an ethylene homopolymer mixture comprising a first ethylene homopolymer and a second ethylene homopolymer.

17. A process for the manufacture of a film, said process comprising:
preparing a multimodal HDPE as defined in claim 14; and
extruding the composition to form a film.

18. A method of use of a multimodal HDPE as defined in claim 14, the method comprising using the multimodal HDPE to manufacture a film.

19. The process as claimed in claim 1, wherein said at least one alpha-olefin is selected from the group consisting of 1-butene, 1-hexene, 1-octene, and mixtures thereof.

20. The film as claimed in claim 14, wherein the film is a blown film.
